(19) United States
(12) Patent Application Publication
(10) Pub. No.: US 2014/0225387 A1
(43) Pub. Date: Aug. 14, 2014

(54) TRIPPER UNIT

(71) Applicant: Myles Huntly, Sydney (AU)

(72) Inventor: Myles Huntly, Sydney (AU)

(73) Assignee: Myles Huntly, Sydney, New South Wales (AU)

(21) Appl. No.: 14/122,882

(22) PCT Filed: May 24, 2012
(86) PCT No.: PCT/AU2012/000581

§ 371 Date: Mar. 27, 2014

(30) Foreign Application Priority Data
May 27, 2011 (AU) 2011902076
Dec. 5, 2011 (AU) 2011101589

(51) Int. Cl. E05C 1/08

(52) U.S. Cl. CPC E05C 1/08
USPC 292/340

(57) ABSTRACT

A tripper unit including a main body and a ramp for engaging a release mechanism of a railway carriage, the ramp being arranged to move between an elevated position and a retracted position, wherein the device further includes a pressurised actuator coupled between the body and the ramp to control movement of the ramp between the elevated and lowered positions in response to pressure applied to the ramp.

### RELATED APPLICATIONS

This application claims priority from Australian Provisional Patent Application No. 2011902076 filed 27 May 2011 and Australian Innovation Patent No. 2011101589 filed 5 Dec. 2011, the contents of which are incorporated herein by reference.

### FIELD OF THE INVENTION

The present invention relates to a tripper unit for opening or closing rolling stock doors.

### BACKGROUND OF THE INVENTION

Rolling stock in the form of bottom dump railway hopper coal wagons are used to haul coal to a coal terminal dump station. The coal wagons have hopper doors which are opened at the dump station to allow the coal to spill into coal receiving bins and on to receiving conveyor belts located at the bottom of the bins.

The doors are opened by releasing an over centre lock and significant force needs to be applied to open the lock.

A trigger device, as shown in FIG. 1, is used for that purpose. The device 1 has a ramped platform 2 that is hinged to a main body 3. The platform 2 is lifted into an operational position by a pneumatic cylinder 4 which pushes a lifting arm 5 into an over-centre, set position. The arm 5 is then supported directly by the main body 3 via intermediate spring 5′. The arm 5 in turn supports a main spring 6 which provides support for platform 2. In the raised position shown, the ramped platform 2 is positioned in line with a roller (not shown) of a release mechanism for the over centre lock on the wagon and the wagon is then slowly rolled forward so that the roller runs along and up the platform.

The main spring 6 provides a reactive force in response to downward pressure from the roller associated with the lock and accommodates a degree of yield deflection, until the lock is forced to release. In an over-yield situation, such as where the lock is not opening, the device has an inbuilt safety feature of being designed to fail catastrophically, in preference to the lock mechanism on the wagon, through the use of shear pins between components of the device 1.

When the device is not in use, the cylinder is actuated to retract piston 4 and draw a follower 8 back from the over-centre, set position and along downwardly curved slot 9 formed in the main body 3, so that the arm is dropped, together with the spring 6 to thereby lower the platform 2. In the lowered position, the platform 2 does not provide any obstruction to those wagons that are not fitted with a release mechanism and associated roller so that those wagons are free to roll over and past the trigger device.

As may be appreciated, the device 1 has many moving parts which are prone to fatigue or failure, particularly in the harsh environment of a coal unloading facility.

Further, if the device fails catastrophically, such as when one of the connections between the various components is broken, there is a need for the device to be replaced or at least taken out of line and repaired, which causes considerable delays in the coal unloading process. The wagon may also be riding slightly higher or lower than anticipated due to either load or manufacturing variation and this can also affect the reliability of the device in opening the wagon doors and/or again cause failure of the device 1 due to resultant overthreshold engagement between the release mechanism and the platform 2.

### OBJECT OF THE INVENTION

It is an object of the invention to provide a tripper unit as an alternative to the above described trigger device.

### SUMMARY OF THE INVENTION

In accordance with the invention, there is provided a tripper unit including a main body and a ramp for engaging a release mechanism of a railway carriage, the ramp being arranged to move between an elevated position and a retracted position, wherein the device further includes a pressurised actuator coupled between the body and the ramp to control movement of the ramp between the elevated and lowered positions in response to pressure applied to the ramp; wherein the actuator includes an air bag unit arranged to accommodate yield deflection of the ramp; and wherein the air bag unit is coupled to a pressure regulator and an overpressure safety valve which allows the ramp to be lowered when an over-threshold pressure is applied to the ramp.

Preferably, the air bag unit is connected at one end to a frame of the main body and is pivotally coupled relative to the ramp at the other end.

In another aspect, there is provided a method of operating a tripper unit, as described above, including pressurising the actuator to hold the ramp is an elevated position and controlling the actuator to lower the ramp when an over-threshold pressure is applied to the ramp.

### BRIEF DESCRIPTION OF THE DRAWINGS

The invention is described, by way of non-limiting example only, with reference to the accompanying drawings, in which:

FIG. 1 is a sectional side view of a prior art trigger device;

FIG. 2 is a diagrammatic illustration showing a tripper unit for opening wagon doors;

FIG. 3 is a perspective view of a tripper unit for closing wagon doors;

FIG. 4 is a diagrammatic sectioned side view of an alternative tripper unit;

FIG. 5 is a view similar to FIG. 4, illustrating a ramp in an elevated position;

FIG. 6 is a diagrammatic sectioned side view of another example of a tripper unit;

FIG. 7 is a side view of the unit of FIG. 6;

FIG. 8 is a side view of the unit of FIG. 6, illustrating a ramp in a lowered position; and

FIG. 9 is a sectioned perspective view of the unit of FIG. 7.

### DETAILED DESCRIPTION OF THE DRAWINGS

Referring to FIG. 2, a tripper unit 10 is shown as including a ramp 11 which is mounted via a pivot connection 12 to a main body 13 of the unit 10. An extension member 14 in the form of a pneumatic actuator 15 is coupled between the main body and the ramp at a position offset from the connection 12 so that operation of the actuator 15 causes the ramp to pivot about the connection 12.

The actuator 15 is preferably in the form of a air bag unit 16 such as a commonly available Firestone Airstroke model 352 highway semi-trailer truck airbag suspension unit. The airbag unit 16 includes a base 17 at one end 18, mounted to a frame 19 of the main body 13, and a pivotable coupling 20 at the other end 21 for connecting the air bag unit 16 relative to the ramp 11.

The air bag unit 16 is capable of moving the ramp 11 to a fully elevated position, as shown, and also accommodating a yield deflection ‘Y’ in the order of 100 mm. The air bag unit 16 is also able to be de-pressurised, in order to drop the ramp 11 into a retracted position which is substantially horizontal, in line with a leading edge 22 of the ramp 11.

The air bag unit 16 is connected into a pneumatic control system 33 via a single line 24. The control system 23 includes a 24 volt solenoid pneumatic air valve 25 which directs air pressure either into or out of the air bag unit 16 through the line 24. The pneumatic air valve 25 is connected to a pressure regulator 26 which receives input pressurised air at, for example, 100 psi. The air valve 25 is also connected to an overpressure safety valve 27 and an air outlet 28.

In use of the device, a roller of a release mechanism for an over centre lock on a wagon (not shown) is brought into engagement with the ramp 11 and moved from right to left, as shown in FIG. 2. The pressure regulator 26 and air valve 25 are operated to ensure the air bag unit 16 is provided with sufficient air pressure to produce a reaction force to the roller whilst allowing for some deflection. If the roller exerts a yield force above a maximum threshold level, for example, 1.5 tonne the overpressure safety valve 27 is activated to allow the pressure within the air bag unit 16 to vent to atmosphere, which causes the air bag unit 16 to collapse, thereby moving the ramp 11 to a retracted position. As a result, the tripper unit 10 is not only able to accommodate a degree of yield but is also able to provide a safety feature in lowering the ramp 11 in an over-yield condition to avoid mechanical damage to both the over centre lock of the wagon and the tripper unit itself.

The over centre lock can then be checked for a jamb and/or the operating parameters of the tripper unit may be adjusted accordingly to more reliably open the over centre lock such as by modifying the pressure supplied to the air bag unit 16 to vary the yield deflection or the height of the ramp. Those modifications may be readily made if adjustments are required for the purpose of, for example, more positively engaging a roller of the wagon that may be at a slightly different height to normal.

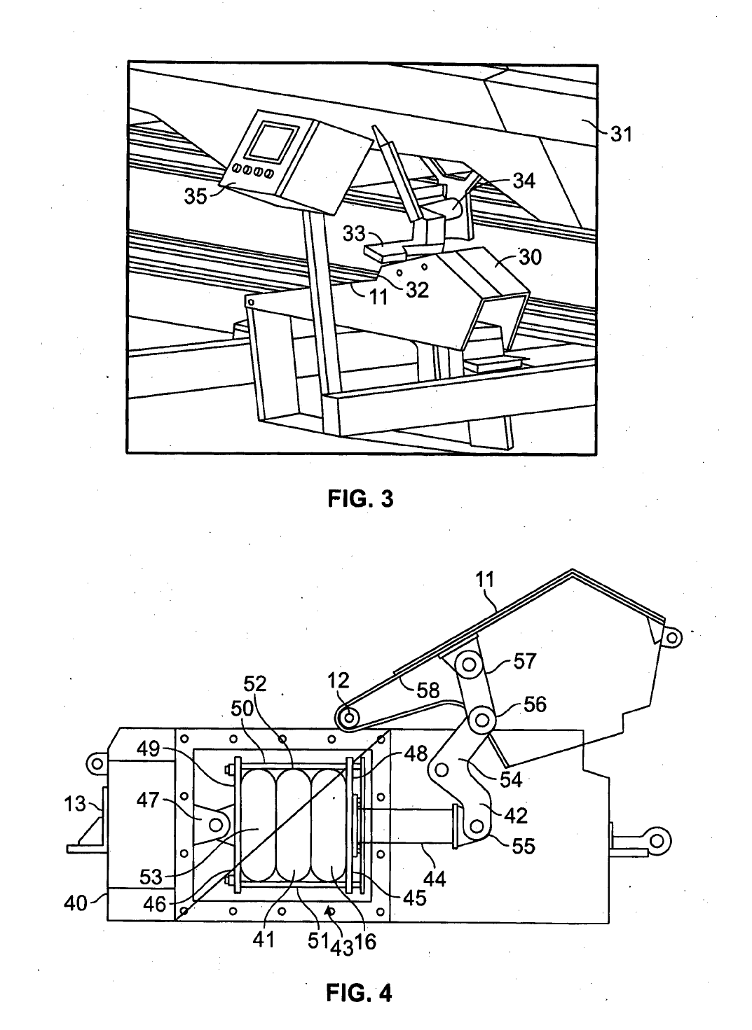

Referring now to FIG. 3, another tripper unit 30 is shown beneath a railway carriage/wagon 31. The tripper unit 30 is generally of the same construction as tripper unit 10, with the exception the ramp 11 has a stepped profile 32 designed to engage a roller 33 of a closing mechanism 34 of the wagon which is coupled to the over centre lock (not shown). In this case, the wagon moves from left to right, as viewed, so that the roller 33 travels up the ramp to activate the closing mechanism 34 so as to close and lock the associated wagon door, after discharge of the coal.

The operation of the tripper unit 30 is identical to that of the unit 10 and can be adjusted by way of console 35. A similar console can also be used with the tripper unit 10.

Accordingly, it should be appreciated the tripper units 10, 30 can provide both door open/close forces as well as retract capability. The control system 23 and console 35 enable immediate adjustment of the tripper height and yield force. This also provides operators with immediate safe access to the tripper units 10, 30 for adjustment and calibration.

Further, the construction of the tripper units 10, 30 is considerably simpler than the prior art trigger device with substantially fewer moving parts that may be subject to wear and fatigue. Maintenance and repair of the tripper units 10, 30 is thereby significantly simplified. Since the air bag unit 16 has a release valve, which causes the bag unit 16 to simply collapse and vent to atmosphere in an overthreshold environment, the units 10, 30 will not be subject to mechanical failure, which is designed into the trigger unit 1. Also, the main active component of the trigger units 10, 30 is the air bag unit 16, which can be an off-the-shelf component which helps further reduce the comparative costs of the units 10, 30. In the event the air bag unit 16 does fail during operation the damaged air bag unit can be readily and rapidly swapped out without any significant delay to the coal unloading process, as compared to possible component failure in the trigger device.

In addition to the above, the tripper units 10, 30 may also include a wear plate (not shown) which can be secured on top of the ramp for correct engagement with the lock releasing mechanism of the carriage and, in the event of excess wear, the plate may simply be replaced, while the tripper unit itself remains operational. This is again different from the prior art trigger device which would require the entire device to be removed and repaired.

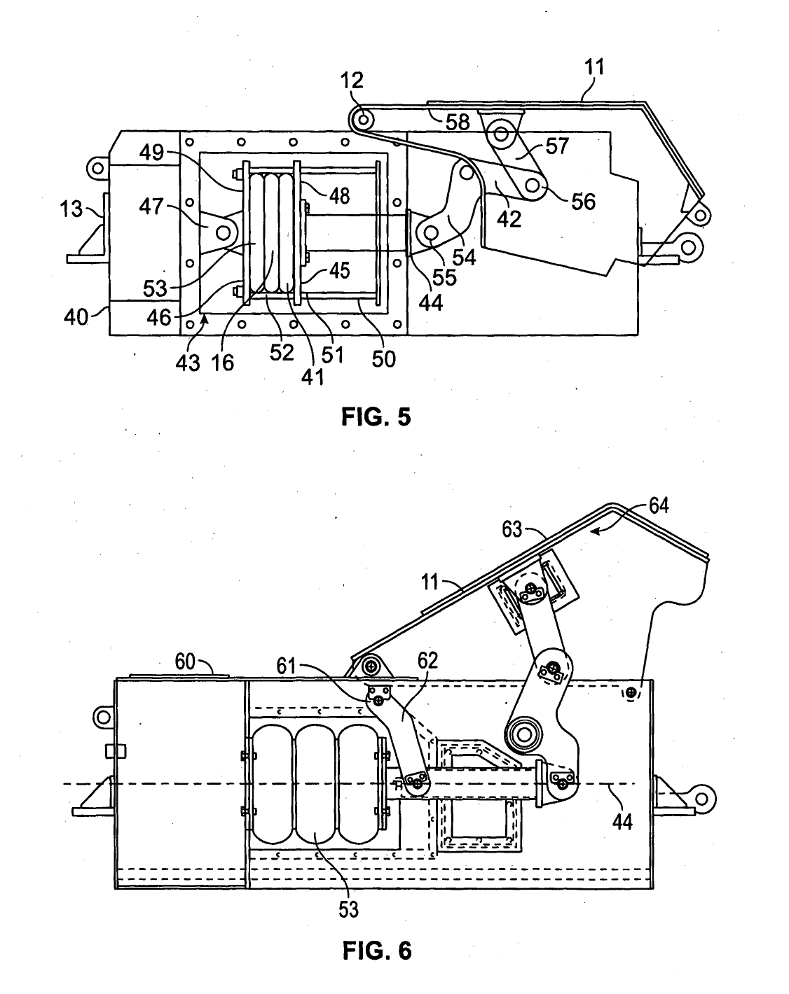

An alternative form of tripper unit 40 is described with reference to FIGS. 4 and 5, where like reference numerals are used to denote like parts.

The unit 40 is shown as having a ramp 11 mounted to the main body 13 at a pivot connection 12 and an actuator 41 coupled to the ramp 11 via a linkage 42. The actuator 41 serves to move the ramp 11 between an elevated position, shown in FIG. 4, to a lowered position shown in FIG. 5.

The actuator 41 is housed within a compartment 43 of the main body 13 and is connected to an extension member 44 which projects from the compartment 43, to connect to the linkage 42. The member 44 is mounted to a first end 45 of the actuator 41 and the second end 46 of the actuator 41 is anchored to a bracket 47 within the compartment 43.

The actuator 41 is an airbag unit 16 which has a travelling plate 48 forming the first end 45 of the actuator 41 and a fixed base plate 49 forming the second end 46. The airbag unit 16 also includes a guide assembly 50 which comprises a cage 51 with guide posts 52 that extend from the fixed base plate 49 of the unit 16. The travelling plate 48 is mounted for sliding movement along the posts 52 so that any expansion or contraction of a bladder 53 of the unit 16 results in linear travel of the plate 48, in a direction defined by the guide assembly 50.

As a result, any movement from the actuator 41 translates into linear movement of the extension member 44, which in turn causes the ramp 11 to be raised or lowered through the linkage 42.

The linkage 42 is formed of an L-shaped section 54 which is pivotally connected at one end 55 to the extension member 44 and, at the other end 56, to a pivot arm 57 attached to an underside 58 of the ramp 11.

The section 54 is connected to the body 13, intermediate the ends 55, 56, so as to rotate clockwise, as viewed, when the member 44 is moved to the left. This has the effect of lowering the arm 57 and thereby the ramp 11. The member 44 is moved by collapsing the bladder 53 of the airbag unit 16, in order to draw the plate 48 along the guide assembly 50 to a position shown in FIG. 5, where the extension member 44. is retracted and the ramp 11 is in the fully lowered position. To return the ramp 11 to the elevated position, the actuator 41 is simply engaged to move the member 44 to the right, as viewed, which causes the section 54 to rotate anticlockwise, to lift the arm 57 and thereby the ramp 11 back to the position shown in FIG. 4.

Referring now to FIGS. 6 to 8, another example of a tripper unit 60 is shown. Many components of the tripper unit are the same as those of the units 10, 30 and 40 and like reference numerals will be used to denote like parts.

In FIG. 6, the unit 60 can be seen as being substantially the same as the unit 40 described with reference to FIGS. 4 and 5. However, the unit 60 has a differently configured guide assembly 61. Instead of a cage 51, the assembly 61 includes a pivotal arm 62 which attaches to the body 13 and connects directly with the extension member 44. A second arm (not shown) is attached in a similar manner to the opposite side of the member 44. In that manner, the member 44 is constrained against lateral, off-axis movement when the bladder 53 is expanded and contracted to drive the extension member 44 to lift or lower the ramp 11.

The ramp 11 in FIG. 6 is also clearly illustrated as having a wear plate 63. The wear plate 63 does not need to be provided over the entire ramp 11 and, accordingly, the plate 63 extends over only a section 64 of the ramp 11 that is likely to be engaged by the lock release or door closing mechanism of a rail wagon.

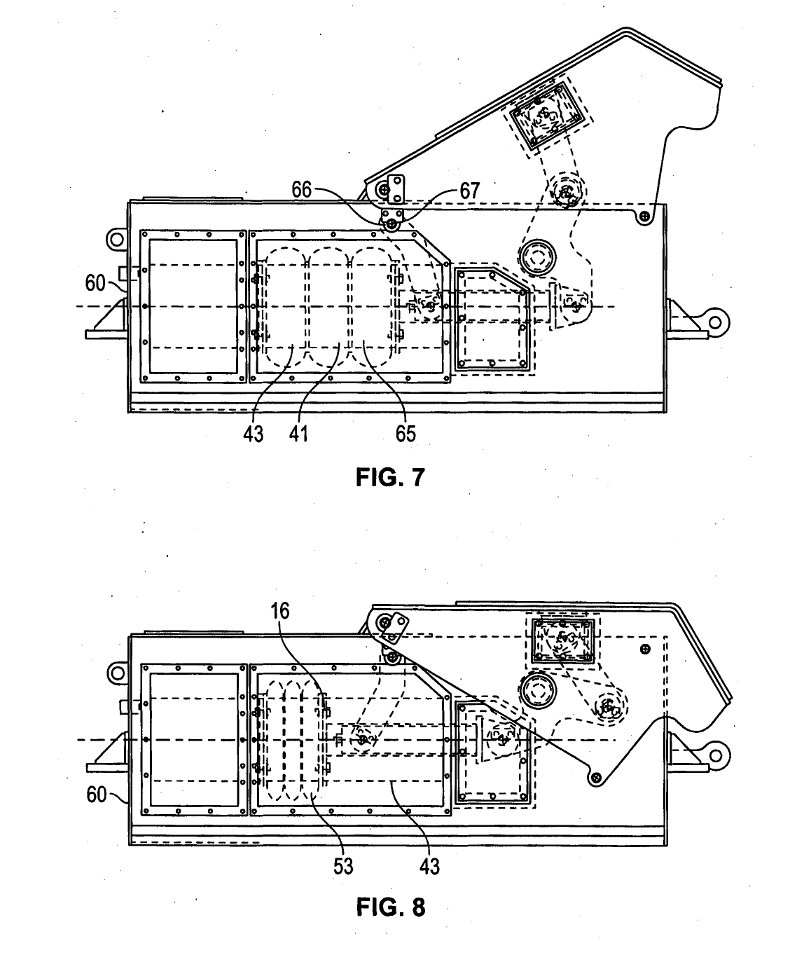

Turning now to FIG. 7, the unit 60 is illustrated with a cover 65 over the compartment 43 in which the actuator 41 is housed. As may be appreciated, the actuator 41 is thereby protected from the otherwise damaging environment in which the unit is located during operation. FIG. 7 also illustrates a safety lock 66 in the main body 13, which is adapted to receive a bolt 67 or the like, to hold the ramp 11 in the elevated position during maintenance.

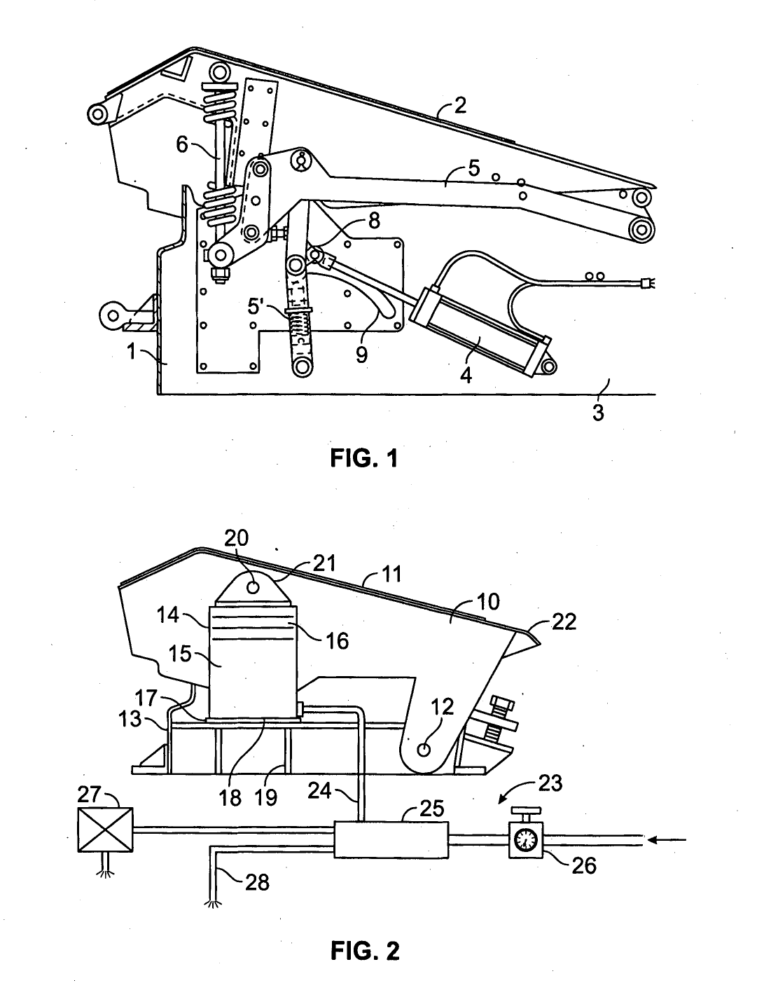

With regard to FIG. 8, the ramp 11 is shown in the lowered position and the bladder 53 of the air bag unit 16 is illustrated in a retracted condition within the compartment 43 in the main body 13. It can again be seen the unit 60 provides a neat and modular alternative to the prior art trigger device 1, described with reference to FIG. 1.

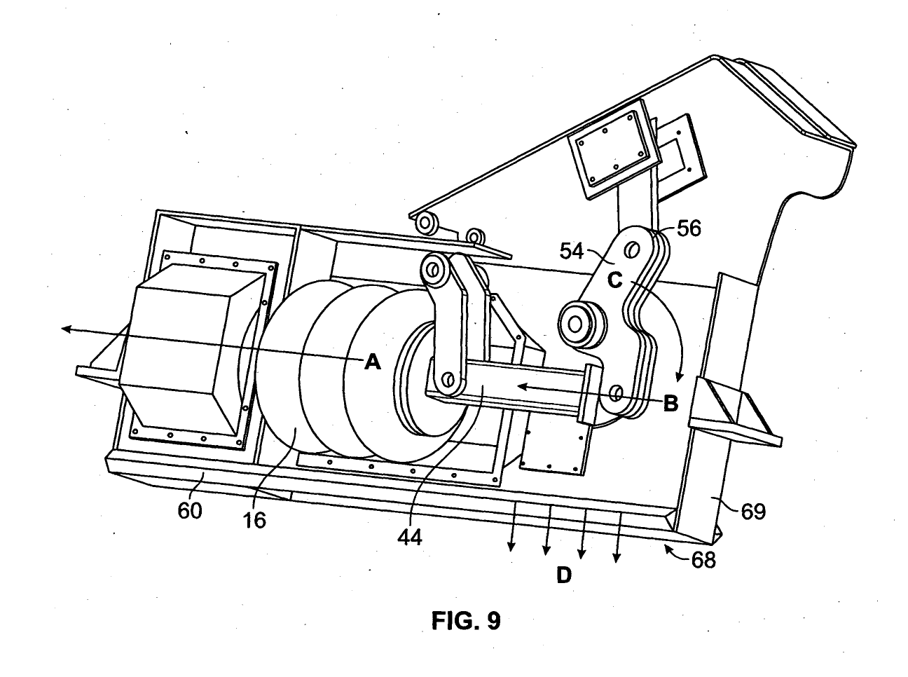

Referring now to FIG. 9, operation of the unit 60 is illustrated by reference to a sectioned perspective view. To move the ramp 11 from the elevated position shown to a lowered position, the unit 16 is collapsed in a direction indicated by arrow A. This has the effect of drawing the main push bar or extension member 44 in a corresponding direction, indicated by arrow B, to pivot the bell crank or section 54 in a direction indicated by arrow C. This arrangement has a particular advantage in so far as the end 56 of the crank/section 54 rotates down toward a clearance opening 68 in a base 69 of the unit 60 and this serves to clear the opening 68 and eject coal or debris that may have accumulated inside the unit 60. Any coal ejected by the crank 65 is free to drop clear of the unit 60 in a direction indicated by arrows D, directly into a bin or hopper station located beneath the unit. The unit 60 is thereby provided with a self-clearing function whenever the ramp 11 is retracted to a lowered position, which prevents build-up of any obstructing foreign material that might otherwise cause fouling and inhibit proper functioning of the unit 60.

As may be appreciated, the airbag unit 16 need not be restricted to any particular orientation provided the ramp 11 can be operated by direct action of the airbag unit 16 and the associated extension member 44, to maintain the elevated position of the ramp, while accommodating a required degree of yield. An important feature is that air pressure within the unit 16 may be vented if an above threshold level is applied to the ramp, to allow the ramp 11 to be lowered, before mechanical failure of the component parts.

An air bag unit has been described as the preferred form of mechanism for achieving the invention, as the intended air bag units are readily and commercially available at comparatively low cost, for example, in the form of the Firestone Air Stroke actuator model number 352. Also, if an over threshold pressure is applied to the ramp 11, air can be readily vented to atmosphere without any environmental damage.

However, any other form of pressurised fluid system could instead be used, such as, for example, a hydraulic system to achieve a similar result. An overriding feature of such a system would be the capacity to lower the ramp or depressurise the system in an over threshold pressure condition, prior to mechanical failure. Such a system should also allow the ramp a degree of yield deflection during normal operation.

It should also be noted the actuator 41 has been generally described by reference to the linear actuation of the extension member 44, however, other forms for actuators may instead be used if convenient, such as rotary actuators which could even be connected directly to the ramp 11.

The invention has been described by way of non-limiting example only and many modifications and variations may be made without departing from the spirit and scope of the invention as described.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

### LIST OF PARTS

1. Trigger device

2. Platform

3. Main body

4. Pneumatic cylinder

5. Lifting arm

6. Main spring

7. Piston

8. Follower

9. Curved slot

10. Tripper unit

11. Ramp

12. Pivot connection

13. Main body

14. Extension member

15. Pneumatic actuator

16. Air bag unit

17. Base

18. End

19. Frame

20. Coupling

21. End

22. Leading edge

23. Control system

24. Line

25. Valve

26. Pressure regulator.

27. Safety valve

28. Outlet

30. Tripper unit

31. Carriage/wagon

32. Profile

33. Roller

34. Closing mechanism

35. Console

40. Tripper unit

41. Actuator

42. Linkage

43. Compartment

44. Extension member

45. First end

46. Second end

47. Bracket

48. Plate

49. Plate

50. Guide assembly

51. Cage

52. Posts

53. Bladder

54. Section

55. End

56. End

57. Pivot arm

58. Underside

60. Tripper unit

61. Guide assembly

62. Arm

63. Wear plate

64. Section

65. Cover

66. Safety lock

67. Bolt

68. Opening

69. Base

1. A tripper unit including a main body and a ramp for engaging a release mechanism of a railway carriage, the ramp being arranged to move between an elevated position for engagement with the release mechanism and a retracted position where the ramp is removed from a position of engagement with the release mechanism, the device further includes the tripper unit having an actuator that is pressurised to control movement of the ramp between the elevated and lowered positions and lowers the ramp to the retracted position in response to pressure applied to the ramp.

2. The tripper unit of claim 1, wherein the actuator is a pneumatic actuator arranged to accommodate yield deflection of the ramp.

3. The tripper unit of claim 1, wherein the actuator is coupled to a pressure regulator and an overpressure safety valve which allows the ramp to be lowered when an over-threshold pressure is applied to the ramp.

4. The tripper unit of claim 3, wherein the actuator is an air bag unit.

5. The tripper unit of claim 4, wherein the actuator is connected at one end to a frame of the main body and pivotally coupled relative to the ramp at the other end.

6. The tripper unit of claim 1, wherein the actuator is coupled to the ramp via a crank that pivots, as the ramp moves between the raised and lowered positions, toward an opening provided in a base of the tripper unit to clear and eject any obstructing foreign material from within the tripper unit, so as to provide a self-clearing function whenever the ramp is lowered.

7. A method of operating the tripper unit of claim 1, including pressurising the actuator to hold the ramp in an elevated position and controlling the actuator to lower the ramp when an over-threshold pressure is applied to the ramp.

8. A tripper unit, substantially as described with reference to the drawings and/or examples.

9. A method of operating a tripper unit, substantially as described with reference to the drawings and/or examples.
